(19) United States
(12) Patent Application Publication
(10) Pub. No.: US 2017/0018245 A1
(43) Pub. Date: Jan. 19, 2017

(54) GATE DRIVING CIRCUIT AND DISPLAY APPARATUS HAVING THE SAME

(71) Applicant: SAMSUNG DISPLAY CO., LTD., Yongin-si (KR)

(72) Inventors: Junhyun Park, Suwon-si (KR); Kyoung-ju Shin, Hwaseong-si (KR)

(21) Appl. No.: 15/080,515

(22) Filed: Mar. 24, 2016

(30) Foreign Application Priority Data
Jul. 17, 2015 (KR) 10-2015-0101934

(51) Int. Cl. G09G 3/36

(52) U.S. Cl. CPC G09G 3/3688; G09G 2300/0426; G09G 2310/0251; G09G 2310/061; G09G 2310/08; G09G 2300/0819

(57) ABSTRACT

A gate driving circuit includes driving stages to provide gate signals to gate lines of a display panel, a k-th driving stage (where k is a natural number greater than 2) of the driving stages including an output unit to output a k-th gate signal to a k-th gate line and a k-th carry signal to a k-th carry terminal in response to a voltage of a first node, a control unit to control a potential of the first node, a pull-down unit to pull down the k-th gate line and the k-th carry terminal to a ground voltage in response to a (k+1)-th carry signal, and a reset unit to reset the voltage of the first node to the ground voltage in response to the reset signal. The reset unit receives one of the k-th gate signal and the k-th carry signal as a feedback signal.

### CROSS-REFERENCE TO RELATED APPLICATION

This patent application claims priority to and the benefit of Korean Patent Application No. 10-2015-0101934, filed on Jul. 17, 2015, the entire contents of which are hereby incorporated by reference.

### BACKGROUND

1. Field

Aspects of embodiments of the present invention relate to a gate driving circuit and a display apparatus having the same, and more particularly, to a display apparatus having improved display quality.

2. Description of the Related Art

A display apparatus includes a plurality of gate lines, a plurality of data lines, a plurality of pixels connected to the plurality of gate lines and the plurality of data lines. The display apparatus includes a gate driving circuit that provides gate signals to the plurality of gate lines and a data driving circuit that outputs data signals to the plurality of data lines.

The gate driving circuit includes a shift register including a plurality of driving stage circuits (hereinafter, referred to as driving stages). The plurality of driving stages output gate signals corresponding to the plurality of gate lines, respectively. Each of the plurality of driving stages includes a plurality of transistors that are connected to each other.

### SUMMARY

One or more aspects of embodiments of the present invention provide a gate driving circuit for preventing leakage current from occurring in a first node when an oxide semiconductor transistor is adopted.

One or more aspects of embodiments of the present invention provide a display apparatus that is capable of improving driving quality of a gate driving circuit including a reset unit.

According to an embodiment of the present invention, a gate driving circuit includes: a plurality of driving stages configured to provide a plurality of gate signals to a plurality of gate lines of a display panel, a k-th driving stage (where k is a natural number greater than 2) of the plurality of driving stages including: an output unit configured to output a k-th gate signal to a k-th gate line of the gate lines and a k-th carry signal to a k-th carry terminal in response to a voltage of a first node; a control unit configured to control a potential of the first node; a pull-down unit configured to pull down the k-th gate line and the k-th carry terminal to a ground voltage in response to a (k+1)-th carry signal received through a (k+1)-th carry terminal; and a reset unit configured to reset the voltage of the first node to the ground voltage in response to a reset signal received through a reset terminal, wherein the reset unit receives one of the k-th gate signal and the k-th carry signal as a feedback signal.

The reset unit may include a first reset transistor including a first electrode connected to the first node, a second electrode connected to a connection node, and a gate electrode connected to the reset terminal; and a second reset transistor including a first electrode connected to the connection node, a second electrode connected to the ground voltage, and a gate electrode connected to the reset terminal, wherein the feedback signal is provided to the connection node.

The reset unit may further include a feedback transistor including a first electrode connected to the k-th gate line, a second electrode connected to the connection node, and a gate electrode connected to the k-th gate line.

The reset unit may further include a feedback transistor including a first electrode connected to the k-th carry terminal, a second electrode connected to the connection node, and a gate electrode connected to the k-th carry terminal.

The reset unit may further include a third reset transistor including a first electrode connected to the k-th gate line, a second electrode connected to the ground voltage, and a gate electrode connected to the reset terminal.

The reset unit may further include a fourth reset transistor including a first electrode connected to the k-th carry terminal, a second electrode connected to the ground voltage, and a gate electrode connected to the reset terminal.

The output unit may include: a first output transistor including a first electrode configured to receive a clock signal, a second electrode configured to output the k-th gate line that is generated based on the clock signal, and a gate electrode connected to the first node; and a second output transistor including a first electrode configured to receive the clock signal, a second electrode configured to output the k-th carry signal that is generated based on the clock signal, and a gate electrode connected to the first node.

The control unit may output a first control signal to the first node in response to a (k−1)-th carry signal from a (k−1)-th carry terminal before the k-th gate signal is outputted.

The control unit may include first and second control transistors connected in series between the (k−1)-th carry terminal and the first node, and wherein each of the first and second control transistors has which a gate electrode connected to the (k−1)-th carry terminal.

The gate driving circuits may further include a third control transistor diode-connected to a connection node between the k-th carry terminal and first and second output transistors of the output unit.

The gate driving circuits may further include a discharge unit including first and second discharge transistors connected in series between the first node and the ground voltage, and wherein each of the first and second discharge transistors has a gate electrode connected to the (k+1)-th carry terminal.

The reset unit may include: a first reset transistor diode-connected between the first node and a connection node; and a second reset transistor including a first electrode connected to the connection node, a second electrode connected to the ground voltage, and a gate electrode connected to the reset terminal.

According to an embodiment of the present invention, a display apparatus includes: a display panel including a plurality of pixels configured to display an image, a plurality of gate lines configured to receive a plurality of gate signals so as to drive the plurality of pixels, and a plurality of data lines configured to receive a plurality of data signals; a gate driving circuit on the display panel, the gate driving circuit being configured to supply the gate signals to the plurality of gate lines; and a data driving circuit configured to supply the data signals to the plurality of data lines, wherein the gate driving circuit includes a plurality of driving stages configured to supply the gate signals to the gate lines, a k-th driving stage (where k is a natural number greater than 2) of the plurality of driving stages including: an output unit configured to output a k-th gate signal to a k-th gate line of the gate lines and a k-th carry signal to a k-th carry terminal in response to a voltage of a first node; a control unit configured to control a potential of the first node; a pull-down unit configured to pull down the k-th gate line and the k-th carry terminal to a ground voltage in response to a (k+1)-th carry signal received through a (k+1)-th carry terminal; and a reset unit configured to reset the voltage of the first node to the ground voltage in response to a reset signal received through a reset terminal, wherein the reset unit receives one of the k-th gate signal and the k-th carry signal as a feedback signal.

The reset unit may include a first reset transistor including a first electrode connected to the first node, a second electrode connected to a connection node, and a gate electrode connected to the reset terminal; and a second reset transistor including a first electrode connected to the connection node, a second electrode connected to the ground voltage, and a gate electrode connected to the reset terminal, wherein the feedback signal is provided to the connection node.

The reset unit may further include a feedback transistor including a first electrode connected to the k-th gate line, a second electrode connected to the connection node, and a gate electrode connected to the k-th gate line.

The reset unit may further include a feedback transistor including a first electrode connected to the k-th carry terminal, a second electrode connected to the connection node, and a gate electrode connected to the k-th carry terminal.

The reset unit may further include a third reset transistor including a first electrode connected to the k-th gate line, a second electrode connected to the ground voltage, and a gate electrode connected to the reset terminal.

The reset unit may further include a fourth reset transistor including a first electrode connected to the k-th carry signal, a second electrode connected to the ground voltage, and a gate electrode connected to the reset terminal.

In an embodiment, the gate driving circuit may include a plurality of oxide semiconductor transistors.

### BRIEF DESCRIPTION OF THE DRAWINGS

The accompanying drawings are included to provide a further understanding of aspects of the present invention, and are incorporated in and constitute a part of this specification. The drawings illustrate exemplary embodiments of aspects of the present invention and, together with the description, serve to explain principles of aspects of the present invention. In the drawings:

FIG. 1 is a plan view of a display apparatus according to an embodiment of the present invention;

FIG. 2 is an equivalent circuit view of a pixel of FIG. 1 according to one embodiment of the present invention;

FIG. 3 is a cross-sectional view of the pixel of FIG. 1 according to one embodiment of the present invention;

FIG. 4 is a block diagram of a gate driving circuit of FIG. 1 according to one embodiment of the present invention;

FIG. 5 is a circuit view of a driving stage of FIG. 4 according to one embodiment of the present invention;

FIG. 6 is a view illustrating a wave form of an input/output signal of the driving stage of FIG. 5 according to one embodiment of the present invention;

FIG. 7 is a view illustrating a variation in voltage between a first node and a connection node when a third reset transistor within a reset unit of FIG. 5 is not connected to the connection node according to one embodiment of the present invention;

FIG. 8 is a view illustrating a variation in voltage between the first node and the connection node when the third reset transistor within the reset unit of FIG. 5 is connected to the connection node according to one embodiment of the present invention;

FIG. 9 is a circuit view of a driving stage according to another embodiment of the present invention;

FIG. 10 is a circuit view of a driving stage according to another embodiment of the present invention; and

FIG. 11 is a circuit view of a driving stage according to another embodiment of the present invention.

### DETAILED DESCRIPTION

Hereinafter, exemplary embodiments of the present invention will be described below in more detail with reference to the accompanying drawings.

The objects, means to solve the objects, and effects of aspects of the present invention will be readily understood through embodiments related to the accompanying drawings. Each drawing may be partly simplified or exaggerated for clarity of illustration. Note that the same or similar components in the drawings are designated by the same reference numerals as far as possible even if they are shown in different drawings. Moreover, detailed descriptions related to well-known functions or configurations will be ruled out in order not to unnecessarily obscure subject matters of the present invention.

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

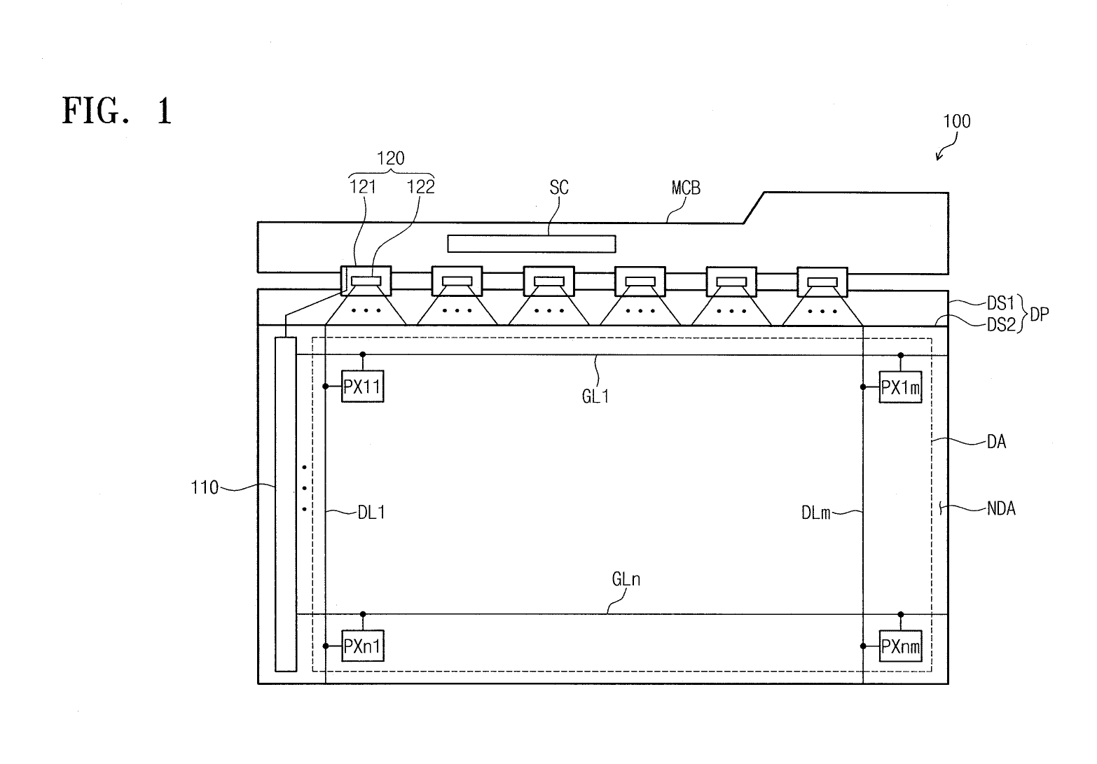

FIG. 1 is a plan view of a display apparatus according to an embodiment of the present invention.

Referring to FIG. 1, a display apparatus 100 according to an embodiment of the present invention includes a display panel DP, a gate driving circuit 110, and a data driving circuit 120.

The display panel DP is not specifically limited to particular types of display panels. For example, the display panel DP may be one of various display panels such as a liquid crystal display panel, an organic light emitting display panel, an electrophoretic display panel, and an electrowetting display panel. In the embodiments of the present invention described below, for the sake of convenience, the liquid crystal display panel will be described as an example of the display panel DP. When the liquid crystal display panel is provided as the display panel DP, the display apparatus 100 may further include a polarizer and a backlight unit.

The display panel DP includes a first substrate DS1, a second substrate DS2 spaced apart from the first substrate DS1, and a liquid crystal layer disposed between the first substrate DS1 and the second substrate DS2. The display panel DP includes a display area DA on which a plurality of pixels PX11 to PXnm are disposed and a non-display area NDA surrounding the display area DA.

The display panel DP includes a plurality of gate lines GL1 to GLn disposed on the first substrate DS1 and a plurality of data lines DL1 to DLm crossing the gate lines GL1 to GLn. The gate lines GL1 to GLn are connected to the gate driving circuit 110. The data lines DL1 to DLm are connected to the data driving circuit 120.

FIG. 1 illustrates only a portion of the pixels PX11 to PXnm. The pixels PX11 to PXnm are connected to the corresponding gate lines of the gate lines GL1 to GLn and the corresponding data lines of the data lines DL1 to DLm, respectively.

The pixels PX11 to PXnm may be divided into a plurality of groups according to displayed colors. The pixels PX11 to PXnm may display one of primary colors. The primary colors may include red, green, blue, and white colors. However, embodiments of the present invention are not limited thereto and the colors emitted by the pixels PX11 to PXnm may include various colors such as a yellow color, cyan, and magenta.

The gate driving circuit 110 and the data driving circuit 120 may receive a control signal from a signal control unit SC (e.g., a timing controller). The signal control unit SC may be mounted on a circuit board MCB. The signal control unit SC receives image data and a control signal from an external graphic control unit. The control signal may include a vertical synchronization signal that is a frame discrimination signal, a horizontal synchronization signal that is a row discrimination signal, a data enable signal having a high level HIGH during only an interval in which data is outputted to display a data input section, and a main clock signal.

The signal control unit SC converts image data to match specifications of the data driving circuit 120 and then outputs the converted image data to the data driving circuit 120. The signal control unit SC generates a gate control signal and a data control signal on the basis of the control signal. The signal control unit SC outputs the gate control signal to the gate driving circuit 110 and outputs the data control signal to the data driving circuit 120.

The gate driving circuit 110 generates gate signals GS1 to GSn on the basis of the gate control signal to output the generated gate signals GS1 to GSn to the gate lines GL1 to GLn. The gate driving circuit 110 may be concurrently (e.g., simultaneously) formed together with the pixels PX11 to PXnm through a thin film process. For example, the gate driving circuit 110 may be formed in the form of an amorphous silicon TFT gate driver circuit (ASG) or oxide semiconductor TFT gate driver circuit (OSG) on the non-display area NDA.

One gate driving circuit 110 connected to ends of the gate lines GL1 to GLn is illustrated as an example in FIG. 1. However, according to another embodiment of the present invention, the display apparatus 100 may include two gate driving circuits. One gate driving circuit of the two gate driving circuits may be connected to one of the ends (e.g., left ends) of the gate lines GL1 to GLn, and the other gate driving circuit may be the other ends (e.g., right ends) of the gate lines GL1 to GLn. In another embodiment of the present invention, one gate driving circuit of the two gate driving circuits may be connected to odd-numbered gate lines, and the other gate driving circuit may be connected to even-numbered gate lines.

The data driving circuit 120 generates gradation voltages according to the image data provided from the signal control unit SC on the basis of the data control signal received from the signal control unit SC. The data driving circuit 120 outputs the gradation voltages to the data lines DL1 to DLm as data voltages.

The data voltages may include positive data voltages having a positive value and negative data voltages having a negative value with respect to a reference voltage. Polarities of the data voltages may be inverted into one frame unit. Alternatively, within one frame a portion of the data voltage may have a positive polarity, and the rest of the data voltages may have a negative polarity.

The data driving circuit 120 may include a driving chip 122 and a flexible circuit board 121 on which the driving chip 122 is mounted. The data driving circuit may include a plurality of driving chips 122 and a plurality of flexible circuit boards 121. The flexible circuit boards 121 electrically connect the main circuit board MCB to the first substrate DS1. Each of the driving chips 122 provides corresponding data signals to corresponding data lines of the data lines DL1 to DLm.

FIG. 1 illustrates an example of a structure in which the driving circuit 120 is provided on the display apparatus 100 in the form of a chip on film. However, the data driving chip 120 may be disposed on the non-display area NDA of the first substrate DS1 in the chip on glass (COG) manner.

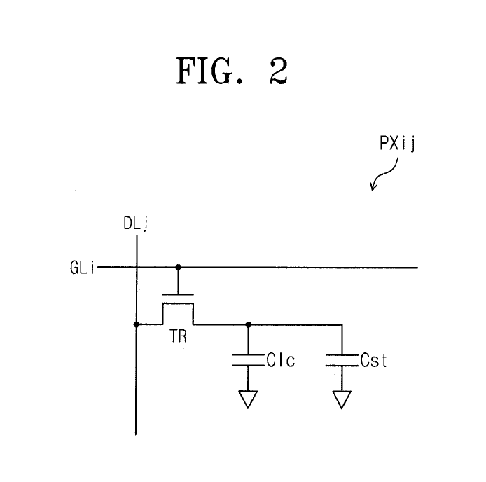

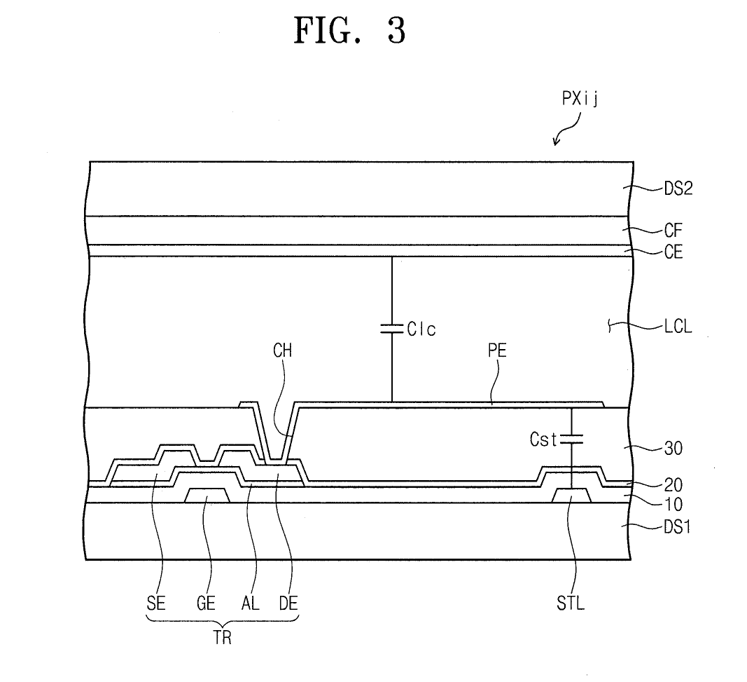

FIG. 2 is an equivalent circuit view of the pixel of FIG. 1 according to one embodiment of the present invention, and FIG. 3 is a cross-sectional view of the pixel of FIG. 1 according to one embodiment of the present invention. Each of the pixels PX11 to PXnm of FIG. 1 may have an equivalent circuit of FIG. 2.

Referring to FIG. 2, an (i×j)-th pixel PXij of the pixels PX11 to PXnm includes a pixel transistor TR, a liquid crystal capacitor Clc, and a storage capacitor Cst. Hereinafter, the transistor in the current embodiment may represent a thin film transistor. The storage capacitor Cst is optional and may be omitted.

The pixel transistor TR may be electrically connected to an i-th gate line GLi and a j-th data line DLj. The pixel transistor TR outputs a pixel voltage corresponding to a data signal received from the j-th data line DLj in response to a gate signal received from the i-th gate line GLi.

The liquid crystal capacitor Clc charges the pixel voltage outputted from the pixel transistor TR. Liquid crystal molecules included in the liquid crystal layer LCL (see FIG. 3) may be changed in arrangement according to an amount of electric charges charged in the liquid crystal capacitor Clc (e.g., based on the voltage across the liquid crystal capacitor Clc). The transmittance of the liquid crystal layer LCL depends on the arrangement of the liquid crystal molecules, thereby controlling the amount of light incident on the liquid crystal layer LCL that is transmitted through the liquid crystal layer LCL. The storage capacitor Cst is connected in parallel to the liquid crystal capacitor Clc. The storage capacitor Cst may maintain the arrangement of the liquid crystal molecules during an interval (e.g., a predetermined interval).

As illustrated in FIGS. 2 and 3, the pixel transistor TR includes a gate electrode (or control electrode) GE connected to the i-th gate line GLi, an active layer (or activation part) AL overlapping the gate electrode GE, a second electrode (e.g., source electrode) SE connected to the j-th data line DLj, and a first electrode (e.g., drain electrode) DE disposed to be spaced apart from the second electrode SE.

The liquid crystal capacitor Clc includes a pixel electrode PE and a common electrode CE. The storage capacitor Cst includes the pixel electrode PE and a portion of a storage line STL overlapping the pixel electrode PE.

The i-th gate line GLi and the storage line STL are disposed on one surface of the first substrate DS1. The gate electrode GE is branched from the i-th gate line GLi. The i-th gate line GLi and the storage line STL may be formed of a metal such as Al, Ag, Cu, Mo, Cr, Ta, and Ti, or a combination thereof. The i-th gate line GLi and the storage line STL may include a multi-layered structure, e.g., a Ti layer and a Cu layer.

A first insulation layer 10 covering the i-th gate line GLi, the gate electrode GE, and the storage line STL is disposed on one surface of the first substrate DS1. The first insulation layer 10 may be an organic layer or inorganic layer. The first insulation layer may include a multi-layered structure, for example, a silicon nitride layer and a silicon oxide layer.

The active layer AL is disposed on the first insulation layer 10 to overlap the gate electrode GE. The active layer AL may include a semiconductor layer and an ohmic contact layer which are successively disposed on the first insulation layer 10.

The semiconductor layer may include amorphous silicon or poly silicon or include a metal oxide semiconductor. The ohmic contact layer may include a dopant doped with density higher than that of the semiconductor layer and be divided into two parts that are spaced apart from each other.

The first electrode DE and the second electrode SE are disposed on the active layer AL. The first electrode DE and the second electrode SE are disposed to be spaced apart from each other. Each of the first and second electrodes DE and SE may partially overlap the gate electrode GE.

A second insulation layer 20 covering the activation layer AL, the first electrode DE, and the second electrode SE is disposed on the first insulation layer 10. The second insulation layer 20 may be an organic layer or inorganic layer. The second insulation layer 20 may include a multi-layered structure, for example, a silicon nitride layer and a silicon oxide layer.

A third insulation layer 30 is disposed on the second insulation layer 20. The third insulation layer 30 provides a planarization surface. The third insulation layer 30 may include an organic material.

The pixel electrode PE is disposed on the third insulation layer 30. The pixel electrode PE is connected to the first electrode DE through a contact hole CH passing through the second and third insulation layers 20 and 30. A lower alignment layer covering the pixel electrode PE may be disposed on the third insulation layer 30.

A color filter layer CF is disposed on one surface of the second substrate DS2. The common electrode CE is disposed on the color filter layer CF. A reference voltage is applied to the common electrode CE. The reference voltage and the pixel voltage may have values different from each other. An upper alignment layer covering the common electrode CE may be disposed on the common electrode CE. An over coating layer formed of an insulation material for planarization may be disposed between the color filter CF and the common electrode CE.

The pixel electrode PE and the common electrode CE disposed with the liquid crystal layer LCL therebetween may form the liquid crystal capacitor Clc. Also, a portion of the pixel electrode PE and the storage line STL, which are disposed with the first, second, and third insulation layers 10, 20, and 30 therebetween may form the storage capacitor Cst. The storage line STL receives a storage voltage having a potential different from that of the pixel voltage. The storage voltage may have the same potential as the reference voltage.

The cross-section of the pixel PXij shown in FIG. 3 is merely one example. In other embodiments of the present invention, unlike the structure of FIG. 3, at least one of the color filter layer CF and the common electrode CE may be disposed on the first substrate DS1. For example, the liquid crystal display panel according to one embodiment may include pixels such as a vertical alignment (AV) mode pixel, a patterned vertical alignment (PVA) mode pixel, an in-plane switching (IPS) mode pixel, a fringe-field switching (FFS) mode pixel, and a plane to line switching (PLS) mode pixel.

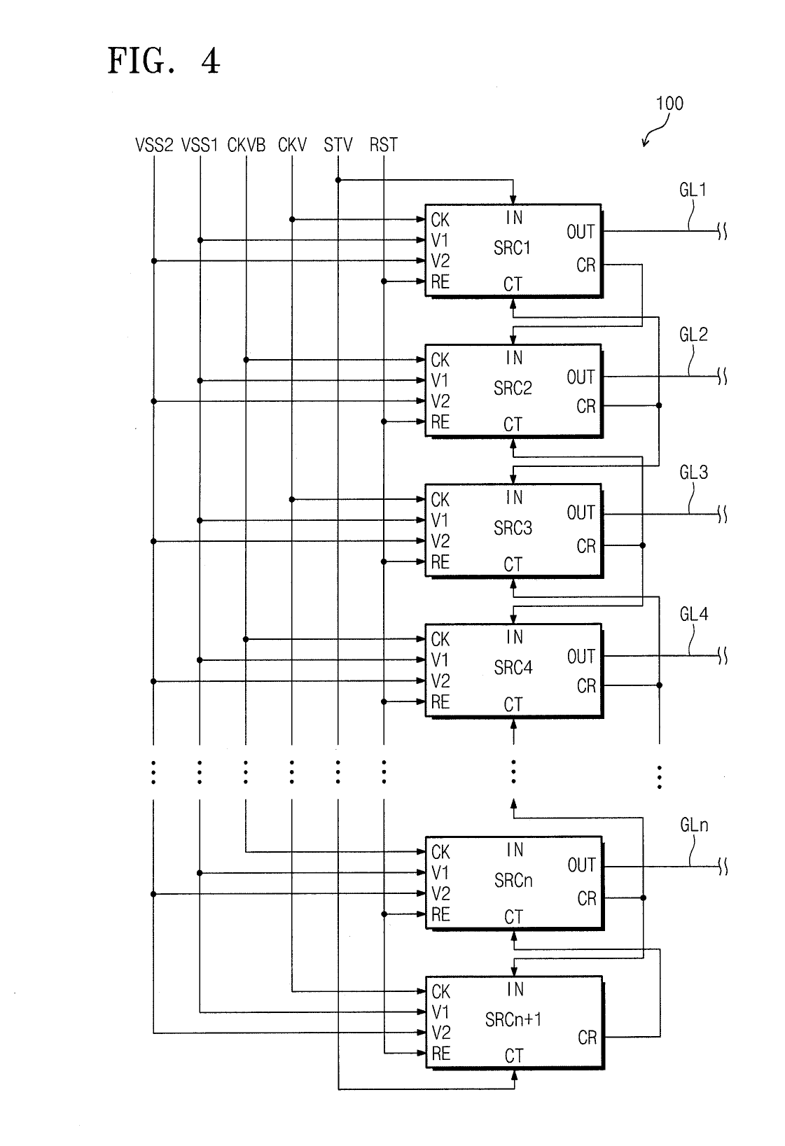

FIG. 4 is a block diagram of the gate driving circuit of FIG. 1.

Referring to FIG. 4, the gate driving circuit 110 includes a plurality of driving stages SRC1 to SRCn. The driving stages SRC1 to SRCn may be subordinately connected to each other and successively driven. The gate driving circuit 110 may further include a dummy stage SRCn+1 (or SRC_D).

In the current embodiment, the driving stages SRC1 to SRCn may be connected to the gate lines GL1 to GLn to provide gate signals to the gate lines GL1 to GLn, respectively.

Each of the driving stages SRC1 to SRCn includes an output terminal OUT, a carry terminal CR, an input terminal IN, a control terminal CT, a clock terminal CK, a first voltage input terminal V1, a second voltage input terminal V2, and a reset terminal RE. The dummy stage SRC_D may have the same circuit configuration as the driving stages SRC1 to SRCn and include the same input/output terminal as the driving stages SRC1 to SRCn. Thus, the driving stages SRC1 to SRCn will be described below, and description with respect to specific constituents of the dummy stage SRC_D will be omitted.

The output terminal OUT of each of the driving stages SRC1 to SRCn is connected to a corresponding gate line of the plurality of gate lines GL1 to GLn. The gate signals generated from the driving stages SRC1 to SRCn are provided to the gate lines GL1 to GLn through the output terminals OUT.

The carry terminal CR of each of the driving stages SRC1 to SRCn is electrically connected to the input terminal IN of the next driving stage that is driven as followed by the corresponding driving stage. The carry terminal CR of each of the driving stages SRC1 to SRCn outputs a carry signal.

The input terminal IN of each of the driving stages SRC1 to SRCn is electrically connected to the carry terminal CR of the former (or previous) stage of the corresponding driving stages. For example, the input terminal IN of the third driving stage SRC3 receives a second carry signal outputted from the carry terminal CR of the second driving stage SRC2. The input terminal IN of the first stage SRC1 may receive a vertical start signal STV. The vertical start signal STV may be a signal included in the gate control signal supplied from the signal control unit SC of FIG. 1 to the gate driving circuit 110.

The control terminal CT of each of the driving stages SRC1 to SRCn is electrically connected to the carry terminal CR of the next driving stage. For example, the control terminal CT of the third driving stage SRC3 receives a fourth carry signal outputted from the carry terminal CR of the fourth driving stage SRC4. The control terminal CT of the dummy driving stage SRCn+1 may receive the vertical start signal SW.

The clock terminal CK of each of the driving stages SRC1 to SRCn receives one of a first clock terminal CKV and a second clock signal CKVB. The clock terminals CK of the odd-numbered driving stages SRC1 and SRC3 of the driving stages SRC1 to SRCn may receive the first clock signal CKV, and the clock terminals CK of the even-numbered driving stages SRC2 and SRCn may receive the second clock signal CKVB. The first clock signal CKV and the second clock signal CKVB may be signals having phases different from each other.

The first voltage input terminal V1 of each of the driving stages SRC1 to SRCn receives a first ground voltage VSS1, and the second voltage input terminal V2 receives a second ground voltage VSS2. The second ground voltage VSS2 may have a voltage level less than that of the first ground voltage VSS1.

In some embodiments of the present invention, each of the driving stages SRC1 to SRCn may omit one of the output terminal OUT, the input terminal IN, the carry terminal CR, the control terminal CT, the clock terminal CK, the first input terminal V1, and the second voltage input terminal V2 or further include other terminals according to the circuit configuration thereof. For example, one of the first and second voltage input terminals V1 and V2 may be omitted. Also, the connection relationship between the driving stages SRC1 to SRCn may variously vary.

The reset terminal RE of each of the driving stages SRC1 to SRCn may receive a reset signal RST supplied from the outside (e.g., the signal control unit of FIG. 1). The reset signal RST holds the gate signals outputted from the gate driving circuit 110 to a low level during a vertical blank interval in addition to the driving interval in which the gate driving circuit 110 is driven.

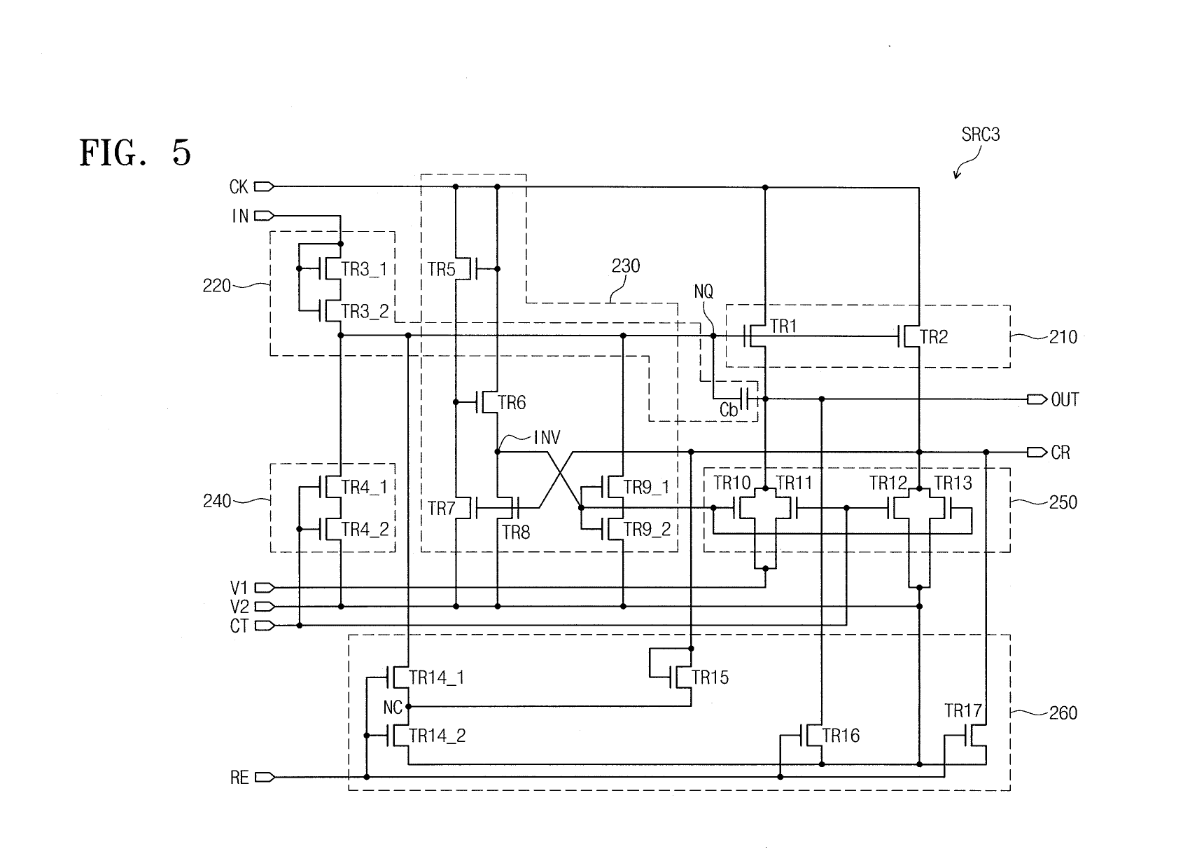

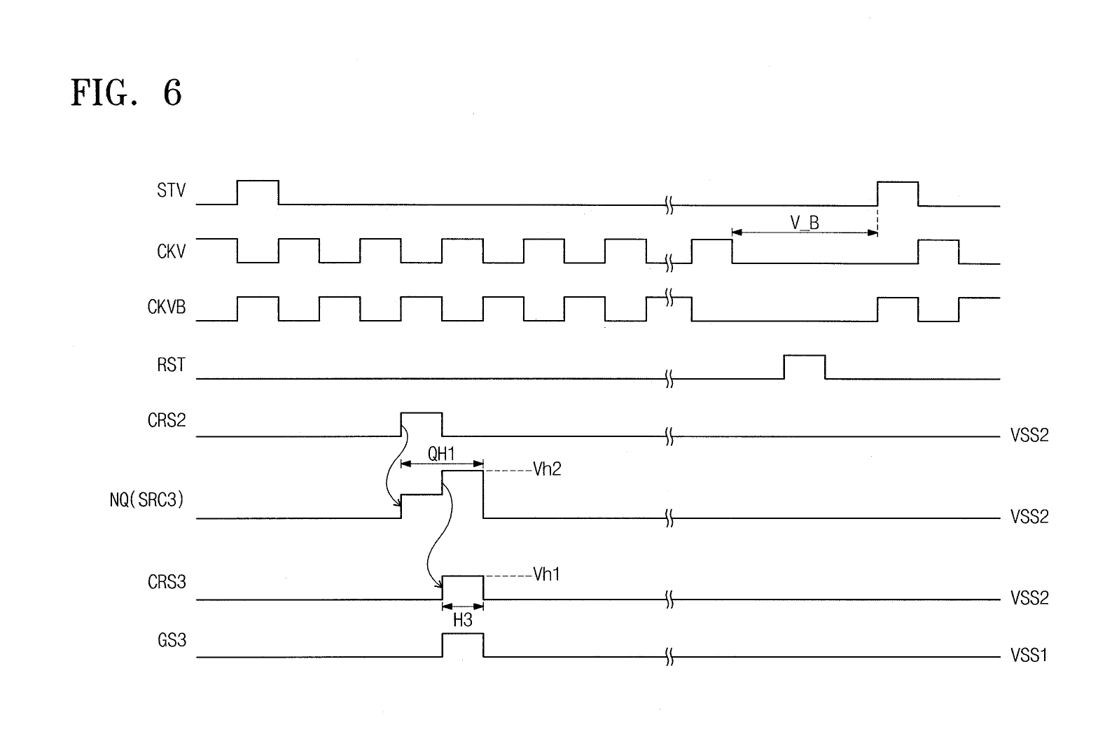

FIG. 5 is a circuit view of the driving stage of FIG. 4 according to one embodiment of the present invention, and FIG. 6 is a view illustrating a wave form of an input/output signal of the driving stage of FIG. 5 according to one embodiment of the present invention.

FIG. 5 illustrates an example of the third driving stage SRC3 of the driving stages SRC1 to SRCn of FIG. 4. Each of the driving stages SRC1 to SRCn of FIG. 5 may have the same circuit configuration as the third driving stage SRC3.

Referring to FIG. 5, the third driving stage SRC3 includes an output unit 210, a control unit 220, an inverter unit 230, a pull-down unit 250, a discharge unit 240, and a reset unit 260.

The output unit 210 includes a first output transistor TR1 outputting a third gate signal GS3 and a second output transistor TR2 outputting a third carry signal CRS3.

The first output transistor TR1 includes a first electrode receiving a first clock signal CKV through the clock terminal CK, a gate electrode connected to a first node NQ, and a second electrode connected to the output terminal OUT outputting the third gate signal GS3. The second output transistor TR2 includes a first electrode receiving the first clock signal CKV through the clock terminal CK, a gate electrode connected to the first node NQ, and a second electrode connected to the carry terminal CR outputting the third carry signal CRS3.

As illustrated in FIG. 6, each of the first clock signal CKV and the second clock signal CKVB includes low intervals having a relatively low voltage level and high intervals having a relatively high voltage level. The first clock signal CKV and the second clock signal CKVB may be signals that are inverted in phase relative to each other, respectively. For example, the first clock signal CKV and the second clock signal CKVB may have a phase difference of 180°. Thus, the low interval of the first clock signal CKV may correspond to the high interval of the second clock signal CKVB, and the high interval of the first clock signal CKV may correspond to the low interval of the second clock signal CKVB.

Referring again to FIG. 5, the control unit 220 is connected to the carry terminal CR of the former (or previous) driving stage (in this example, the second driving stage SRC2) to turn the output unit 210 on in response to the former (or previous) carry signal (hereinafter, referred to as a second carry signal CRS2). For example, the control unit 220 may include a first control transistor TR3_1, a second control transistor TR3_2, and a capacitor Cb.

The first control transistor TR3_1 and the second control transistor TR3_2 are successively connected in series to the input terminal IN and the first node NQ. The first control transistor TR3_1 includes a gate electrode and a first electrode which are connected to the input terminal IN to commonly receive the second carry signal CRS2 of the second driving stage SRC2 (e.g., the first control transistor TR3_1 is diode-connected). The second electrode of the first control transistor TR3_1 is connected to the first electrode of the second control transistor TR3_2. The second control transistor TR3_2 includes a first electrode connected to the second electrode of the first control transistor TR3_1, a second electrode connected to the first node NQ, and a gate electrode connected to the input terminal IN. The capacitor Cb is connected between the second electrode of the first output transistor TR1 and the gate electrode (e.g., the first node NQ) of the first output transistor TR1.

Referring to FIGS. 5 and 6, the first and second control transistors TR3_1 and TR3 2 are turned on in response to the second carry signal CRS2 to boost the potential of the first node NQ up. Thereafter, when the potential of the gate electrode (e.g., the first node NQ) of each of the first and second output transistors TR1 and TR2 is boosted up by the capacitor Cb, the first and second transistors TR1 and TR2 are turned on. Thus, the third carry signal CRS3 having a high level and the third gate signal GS3 having a high level may be outputted through the carry terminal CR and the output terminal OUT, respectively.

As illustrated in FIG. 6, the third carry signal CRS3 has a first high level Vh1 in the high interval (e.g., a third scan interval H3), and the first node NQ of the third stage SRC3 has a second high level Vh2 in the third scan interval H3. For example, the first high level Vh1 may have a potential of about 12 V, and the second high level Vh2 may have a potential of about 30 V that is greater than that of the first high level Vh1.

The pull-down unit 250 pulls down potentials of the third carry signal CRS3 and the third gate signal GS3 in response to the carry signal (e.g., a fourth carry signal CRS4) of the next driving stage (e.g., a fourth driving stage SRC4). For example, the pull-down unit 250 includes pull-down transistors TR10, TR11, TR12, and TR13 for pulling down each of the potentials of the output terminal OUT and the carry terminal CR in response to the second carry signal CRS4.

The first pull-down transistor TR10 includes a first electrode connected to the second electrode of the first output transistor TR1, a second electrode connected to the first voltage input terminal V1, and a gate electrode connected to an inverter node INV within the inverter unit 230. The second pull-down transistor TR11 includes a first electrode connected to the second electrode of the first output transistor TR1, a second electrode connected to the first voltage input terminal V1, and a gate electrode connected to the control terminal CT.

The third pull-down transistor TR12 includes a first electrode connected to the second electrode of the second output transistor TR2, a second electrode connected to the second voltage input terminal V2, and a gate electrode connected to the control terminal CT. The fourth pull-down transistor TR13 includes a first electrode connected to the second electrode of the second output transistor TR2, a second electrode connected to the second voltage input terminal V2, and a gate electrode connected to the inverter node INV within the inverter unit 230. The control terminal CT is connected to the carry terminal CR of the fourth driving stage SRC4 to receive the fourth carry signal CRS4.

The inverter unit 230 of the third driving stage SRC3 includes first, second, third, fourth, fifth, and sixth inverter transistors TR5, TR6, TR7, TR8, TR9_1, and TR9_2. The first inverter transistor TR5 includes a first electrode and a gate electrode which are commonly connected to the clock terminal CK and a second electrode connected to the gate electrode of the second inverter transistor TR6. The second inverter transistor TR6 includes a first electrode connected to the clock terminal CK, a second electrode connected to the inverter node INV, and a gate electrode connected to the second electrode of the first inverter transistor TR5.

The third inverter transistor TR7 includes a first electrode connected to the second electrode of the first inverter transistor TR5, a gate electrode connected to the carry terminal CR, and a second electrode connected to the second voltage input terminal V2. The fourth transistor TR8 includes a first electrode connected to the inverter node INV, a gate electrode connected to the carry terminal CR, and a second electrode connected to the second voltage input terminal V2. According to another embodiment of the present invention, the second electrodes of each of the third and fourth inverter transistors TR7 and TR8 may be connected to the first voltage input terminal V1.

The fifth inverter transistor TR9_1 and the sixth inverter transistor TR9_2 may be successively connected in series between the first node NQ and the second voltage input terminal V2. The gate electrodes of the fifth inverter transistor TR9_1 and the sixth inverter transistor TR9_2 are commonly connected to the inverter node INV.

The first and second inverter transistors TR5 and TR6 are turned on in (or during) the high interval of the first clock signal CKV to output a high voltage of the first clock signal CKV. The third and fourth inverter transistors TR7 and TR8 may operate according to the potential of the carry terminal CR. For example, as illustrated in FIG. 6, the third and fourth inverter transistors TR7 and TR8 are turned on in (or during) the third scan interval H3, in which the third carry signal CR3 outputted to the carry terminal CR has a high level, to pull down the high voltage of the first clock signal CKV outputted from the first and second inverter transistors TR5 and TR6 to the second ground voltage VSS2. The third and fourth inverter transistors TR7 and TR8 are tuned off in (or during) an interval except for (or at all times other than) the third scan interval H3 to output the output voltage, which is outputted from the first and second inverter transistor TR5 and TR6, to the inverter node INV.

Thus, the inverter node INV has a low level corresponding to the second ground voltage VSS2 in the third scan interval H3 and is set to a signal level corresponding to the first clock signal CKV in (or during) an interval except for the third scan interval H3.

Referring again to FIGS. 5 and 6, the discharge unit 240 includes first and second discharge transistors TR4_1 and TR4_2 for pulling down the potential of the first node NQ in response to the fourth carry signal CRS4 of the next driving stage (e.g., the fourth driving stage SRC4).

The first and second discharge transistors TR4_1 and TR_2 are connected in series between the first node NQ and the second voltage input terminal V2. The gate electrodes of the first and second discharge transistors TR4_1 and TR4_2 are commonly connected to the control terminal CT. Particularly, the first discharge transistor TR4_1 includes a gate electrode connected to the control terminal CT to receive the fourth carry signal CRS4, a first electrode connected to the first node NQ, and a second electrode. The second discharge transistor TR4_2 includes a gate electrode connected to the control terminal CT to receive the fourth carry signal CRS4, a first electrode connected to the second electrode of the first discharge transistor TR4_1, and a second electrode connected to the second voltage input terminal V2. Thus, the first and second discharge transistors TR4_1 and TR4_2 discharge the first node NQ to the second ground voltage VSS2 in response to the fourth carry signal CRS4 outputted from the fourth driving stage SRC4.

In an embodiment of the present invention, one of the first and second discharge transistors TR4_1 and TR4_2 may be omitted from the discharge unit 240. Also, in some embodiments of the present invention the first and second discharge transistors TR4_1 and TR4_2 may not be connected to the second voltage input terminal V2, but instead may be connected to the first voltage input terminal V1.

The reset unit 260 includes first to fifth reset transistors TR14_1, TR14_2, TR15, TR16, and TR17. The first reset transistor TR14_1 includes a first electrode connected to the first node NQ, a second electrode connected to the connection node NC, and a gate electrode receiving the reset signal RST through the reset terminal RE. The second reset transistor TR14_2 includes a first electrode connected to the connection node NC, a second electrode connected to the second voltage input terminal V2, and a gate electrode receiving the reset signal RST through the reset terminal RE.

The third reset transistor TR15 includes a first electrode and a gate electrode which are commonly connected to the carry terminal CR and a second electrode connected to the connection mode NC. The third reset transistor TR15 connects the connection node NC, which is disposed between the first and second reset transistors TR14_1 and TR14_2, to the carry signal CRS3 in response to the carry signal CRS3 outputted to the carry terminal CR. For example, the carry signal CRS3 is fed back to the connection node NC between the first and second reset transistors TR14_1 and TR14_2 through the third reset transistor TR15.

The fourth reset transistor TR16 includes a first electrode connected to the output terminal OUT, a second electrode connected to the second voltage input terminal V2, and a gate electrode receiving the reset signal RST through the reset terminal RE.

The fifth reset transistor TR17 includes a first electrode connected to the carry terminal CR, a second electrode connected to the second voltage input terminal V2, and a gate electrode receiving the reset signal RST through the reset terminal RE.

As illustrated in FIG. 6, the gate lines GL1 to GLn are maintained at the low level in (or during) the vertical blank interval V_B. However, the carry signal outputted to the carry terminal CR and the gate signal outputted to the output terminal OUT may be outputted at a high level due to various causes such as static electricity. To prevent or reduce noise from occurring, the first node NQ, the output terminal OUT, and the carry terminal CR may be discharged to the ground voltage level in (or during) the vertical bland interval V_B.

As illustrated in FIG. 6, the reset signal RST is activated to (or supplied at) a high level in (or during) the vertical blank interval V_B. When the reset signal RST is activated to the high level, the first and second reset transistors TR14_1 and TR14_2 discharge the first node NQ to the second ground voltage VSS2. The fourth reset transistor TR16 discharges a voltage of the output terminal OUT to the second voltage VSS2 in response to the reset signal RST. The fifth reset transistor TR17 discharges a voltage of the output terminal OUT to the second voltage VSS2 in response to the reset signal RST.

As described above, when the clock signal is transited to the high level after the carry signal of the former driving stage SRC2 is transited to the high level, the potential of the gate electrode (e.g., the first node NQ) of each of the first and second output transistors TR1 and TR2 is boosted up to the second high level Vh2. When the second ground voltage VSS2 is about −10 V, a voltage difference between the first electrode of the first reset transistor TR14_1 and the second reset transistor TR14_2 may be about 40 V. As described above, when a voltage difference between the drain electrode and the source electrode is large, a threshold voltage shift phenomenon may occur in the transistor due to high voltage stress. When the threshold voltage shift phenomenon occurs in the first and second reset transistors TR14_1 and TR14_2, leakage current may flow through the first and second reset transistors TR14_1 and TR14_2 to reduce the voltage level of the first node NQ.

As illustrated in FIG. 5, the third reset transistor TR15 transmits the carry signal CRS3 of the carry terminal CR to the connection node NC between the first and second reset transistors TR14_1 and TR14_2. When the first node NQ is boosted up to the second high level Vh2, because the carry signal CRS3 has the first high level Vhf, the connection node NC between the first and second reset transistors TR14_1 and TR14_2 may be set to a voltage of about 12 V (e.g., the first high level Vh1). Thus, a voltage difference between the drain and source electrodes of the first reset transistor TR14_1 may be reduced to about 18 V, and a voltage difference between the drain and source electrodes of the reset transistor TR14_2 may be reduced to about 22 V. As described above, the leakage current of the first node NQ due to the high voltage stress of the first and second reset transistors TR14_1 and TR14_2 may be reduced.

The third carry signal SRC3 of the carry terminal CR is transited to the low level after the third carry signal SRC3 is driven at the first high level Vh1 in the third scan interval H3. When the third carry signal SRC3 has a low level, because the third reset transistor TR15 is turned off, the connection node NC may be in a floating state. When the reset signal RST is transited to the high level in the vertical blank interval V_B, the first and second reset transistors TR14_1 and TR14_2 may be turned on to discharge the voltage of the first node NQ to the second ground voltage VSS2. For example, the third reset transistor TR15 may not affect the reset operations of the first and second reset transistors TR14_1 and TR14_2.

In the example of FIG. 5, the first and second reset transistors TR14_1 and TR14_2 may be provided as a single transistor. Here, the single transistor may be a field relaxation transistor (FRT) that includes a floating metal between the first and second electrodes. The first electrode of the single transistor is connected to the first node NQ, the second electrode is connected to the second voltage input terminal V2, and the control terminal is connected to the reset terminal RE. Also, the floating metal of the single transistor may be connected to the second electrode of the third reset transistor TR15.

In another embodiment, each of the fourth and fifth reset transistors TR16 and TR17 may be a field relaxation transistor (FRT). When each of the fourth and fifth reset transistors TR16 and TR17 is the FRT, the second electrode of the third reset transistor TR15 may be commonly connected to the floating metal of the fourth reset transistor TR16 and the floating metal of the fifth reset transistor TR17.

In another embodiment, the fourth reset transistor TR16 is constituted by two transistors connected to each other in series. In this case, the connection nodes of the two transistors connected to the each other in series may be connected to the second electrode of the third reset transistor TR15. Similarly, the fifth reset transistor TR17 may be constituted by two transistors connected to each other in series. In this case, the connection nodes of the two transistors connected to the each other in series may be connected to the second electrode of the third reset transistor TR15.

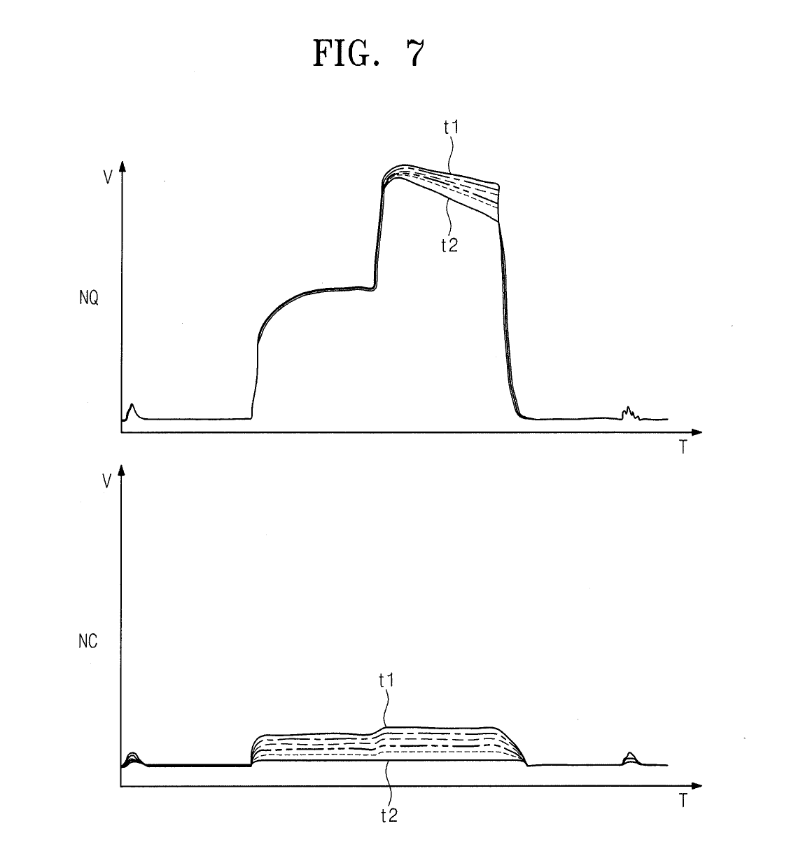

FIG. 7 is a view illustrating a variation in voltage between the first node and the connection node when the third reset transistor within the reset unit of FIG. 5 is not connected to the connection node.

Referring to FIGS. 5 and 7, the third reset transistor TR15 operates for a long time without being connected to the connection node NC between the first and second reset transistors TR14_1 and TR14_2, and then a threshold voltage shift phenomenon of the first and second reset transistors TR14_1 and TR14_2 occurs. Thus, it is seen that the voltage level of the first node NQ is reduced after a long time than an initial time t1 elapses due to the increase of the leakage current through the first and second reset transistors TR14_1 and TR14_2. Particularly, when the voltage level of the first node NQ is reduced so that the first and second output transistors TR1 and TR2 are not turned on after the long time t2 elapses, the gate driving circuit 110 may malfunction.

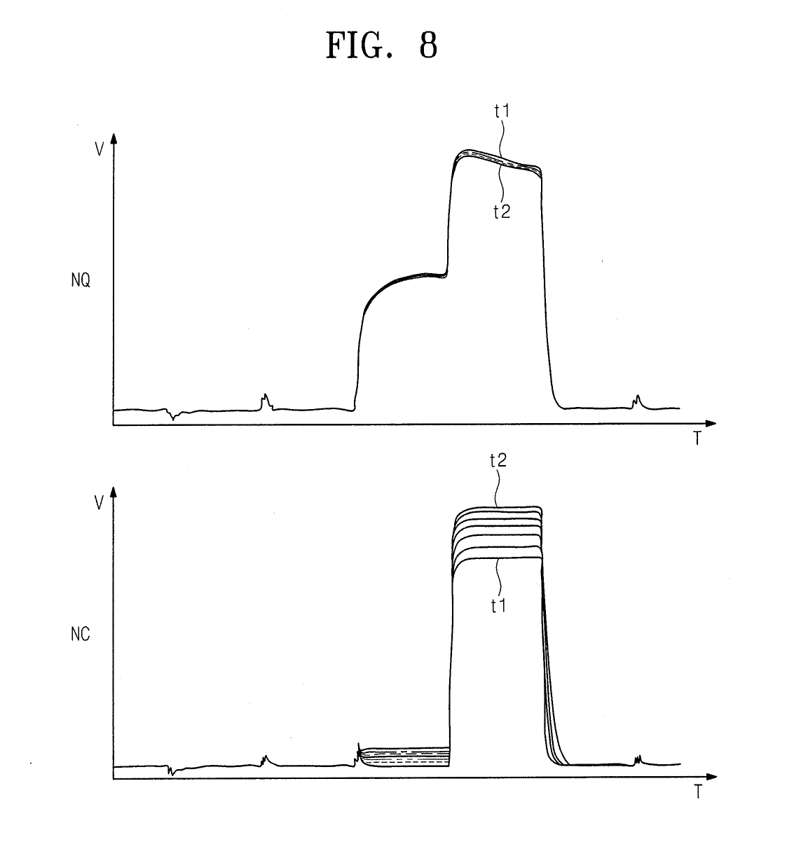

FIG. 8 is a view illustrating a variation in voltage between the first node and the connection node when the third reset transistor within the reset unit of FIG. 5 is connected to the connection node.

Referring to FIGS. 5 and 8, it is seen that the voltage level of the connection node NC increases after the long time t2 than the initial time t1 elapses because the third carry signal CRS3 outputted to the carry terminal CR is repeatedly provided to the connection node NC between the first and second reset transistors TR14_1 and TR14_2.

Also, the high voltage stress phenomenon of the first and second reset transistors TR14_1 and TR14_2 may be removed to reduce the leakage current of the first node NQ. Thus, the voltage level of the first node NQ may not be largely changed after the long time t2 elapses when compared to the initial time t1. Therefore, the gate driving circuit 110 may stably operate.

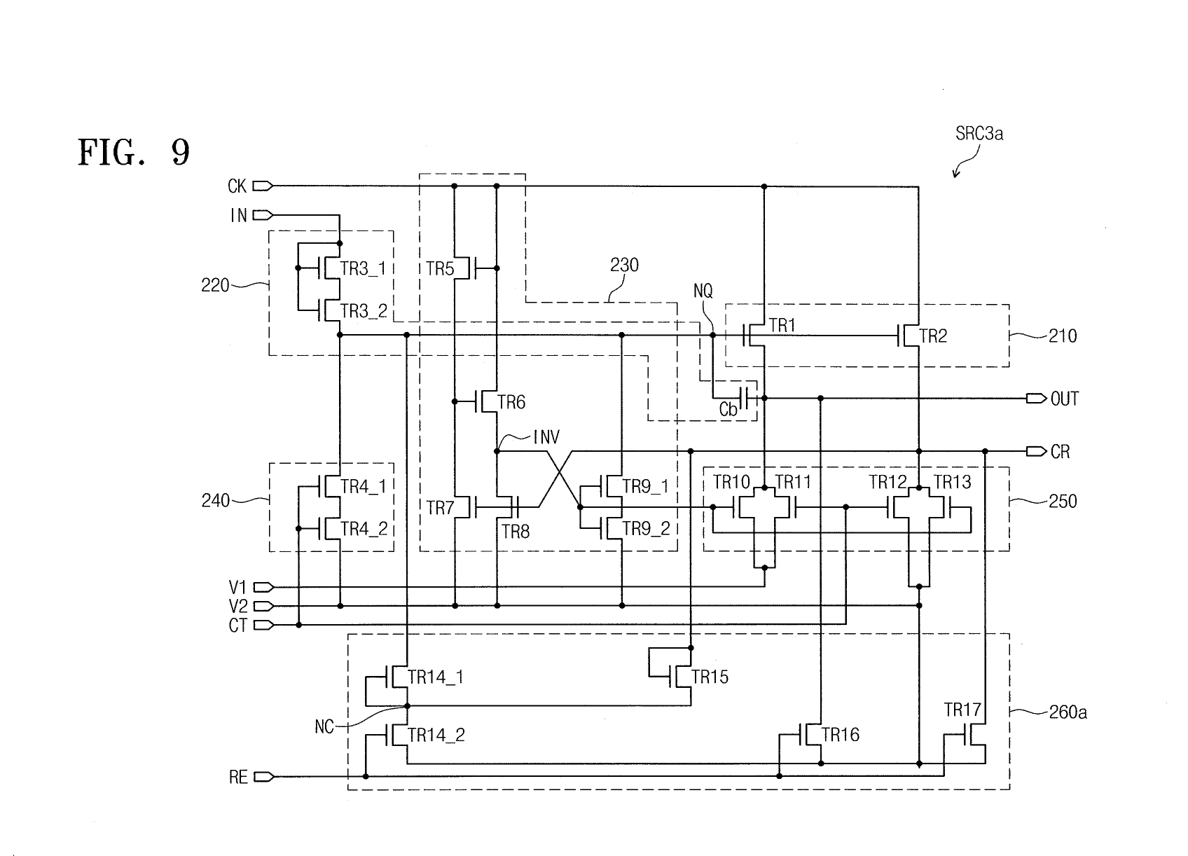

FIG. 9 is a circuit view of a driving stage according to another embodiment of the present invention. Hereinafter, a detailed description of repetitive parts to the above description given with reference to FIG. 5 will be omitted.

Referring to FIG. 9, a driving stage SRC3a has the same constituent except that a driving stage SRC3 and a reset unit 260a are different from those of FIG. 5. In the reset unit 260a, a first reset transistor TR14_1 includes a first electrode connected to a first node NQ and a second electrode and a gate electrode which are commonly connected to a connection node NC. A second reset transistor TR14_2 includes a first electrode connected to a common node, a second electrode connected to a second voltage input terminal V2, and a gate electrode connected to a reset terminal RE. A reset signal RST received through the reset terminal RE has a low level, and the third carry signal CRS3 is provided to the connection node NC during a third scan interval H3. Thus, leakage current of the first and second reset transistors TR14_1 and TR14_2 may be reduced during the third scan interval H3.

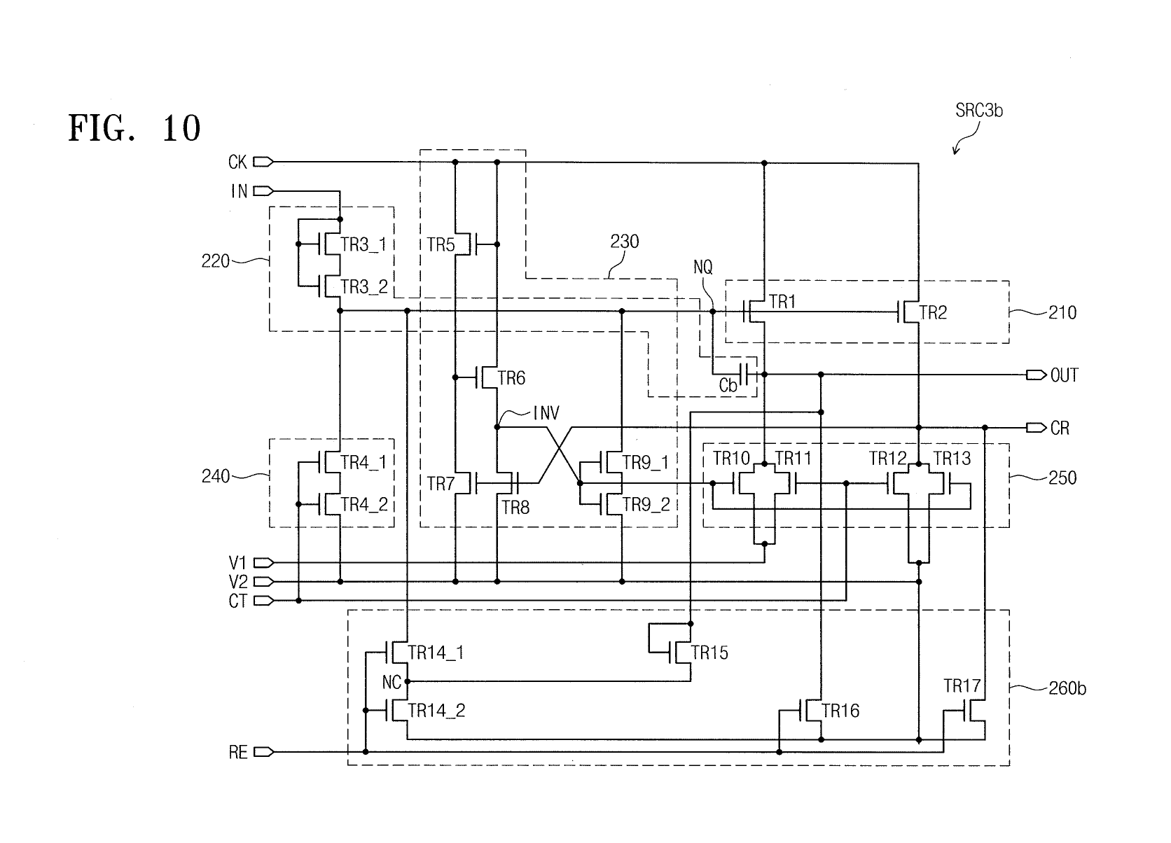

FIG. 10 is a circuit view of a driving stage according to another embodiment of the present invention. Hereinafter, a detailed description of repetitive parts to the above description given with reference to FIG. 5 will be omitted.

Referring to FIG. 10, a driving stage SRC3b has the same constituent except that a driving stage SRC3 and a reset unit 260b are different from those of FIG. 5. In the reset unit 260b, a third reset transistor TR15 includes a first electrode and a gate electrode which are commonly connected to an output terminal OUT and a second electrode connected to a connection node NC. A reset signal RST received through a reset terminal RE has a low level, and a third gate signal GS3 is provided to the connection node NC during a third scan interval H3. Thus, leakage current of the first and second reset transistors TR14_1 and TR14_2 may be reduced during the third scan interval H3.

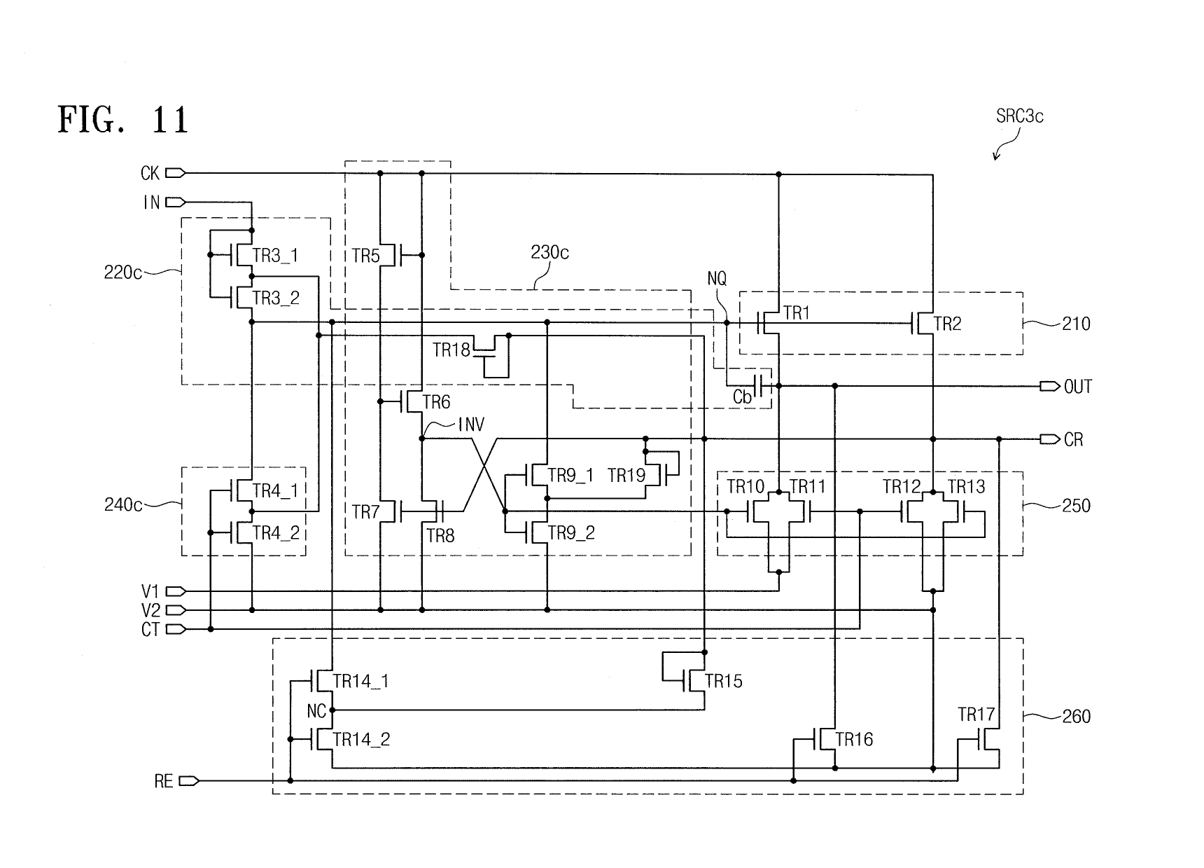

FIG. 11 is a circuit view of a driving stage according to another embodiment of the present invention. Hereinafter, a detailed description of repetitive parts to the above description given with reference to FIG. 5 will be omitted.

Referring to FIG. 11, a driving stage SRC3c has the same constituent except that a driving stage SRC3, a control unit 220c, an inverter unit 230c, and a discharge unit 240c are different from those of FIG. 5. The control unit 220c further includes a first control transistor TR3_1, a second control transistor TR3_2, and a third control transistor TR18. The third control transistor TR18 includes a first electrode and a gate electrode which are commonly connected to a carry terminal CR and a second electrode connected to a connection node between a first control transistor TR3_1 and a second control transistor TR3_2. The second electrode of the third control transistor TR18 is also connected to a connection node between a first discharge transistor TR4_1 and second discharge transistors TR4_1 and TR4_2 within a discharge unit 240c.

A third carry signal CRS3 is provided to the connection node between the first and second control transistors TR3_1 and TR3_2 during a third scan interval H3. Thus, leakage current of the connection node between the first and second control transistors TR3_1 and TR3_2 may be reduced during the third scan interval H3. Similarly, the third carry signal CRS3 is provided to the connection node between the first discharge transistor TR4_1 and the second discharge transistors TR4_1 and TR4_2 during the third scan interval H3. Thus, leakage current of the connection node between the first and second control transistors TR3_1 and TR3_2 may be reduced during the third scan interval H3.

The inverter unit 230c further includes a transistor TR19 in addition to the inverter unit 230 of the driving stage SRC3 of FIG. 5. The transistor TR19 includes a first electrode and a gate electrode which are commonly connected to the carry terminal CR and a second electrode connected to a connection node between a fifth inverter transistor TR9_1 and a sixth inverter transistor TR9_2.

The third carry signal CRSS is provided to the connection node between the fifth inverter transistor TR9_1 and the sixth inverter transistor TR9_2 during the third scan interval H3. Thus, leakage current of the connection node between the fifth inverter transistor TR9_1 and the sixth inverter transistor TR9_2 may be reduced during the third scan interval H3.

According to the embodiments of the present invention, the high-voltage stress of the transistors within the reset unit may be reduced to reduce the leakage current of the first node. Thus, the driving quality of the gate driving circuit including the reset unit may be improved.

It will be apparent to those skilled in the art that embodiments of the present invention are not limited to those described above and that various modifications and variations can be made. Thus, it is intended that embodiments of the present invention cover the modifications and variations of the present invention provided they come within the scope of the claims and equivalents thereof.

What is claimed is:

1. A gate driving circuit comprising:
a plurality of driving stages configured to provide a plurality of gate signals to a plurality of gate lines of a display panel, a k-th driving stage (where k is a natural number greater than 2) of the plurality of driving stages comprising:
an output unit configured to output a k-th gate signal to a k-th gate line of the gate lines and a k-th carry signal to a k-th carry terminal in response to a voltage of a first node;
a control unit configured to control a potential of the first node;
a pull-down unit configured to pull down the k-th gate line and the k-th carry terminal to a ground voltage in response to a (k+1)-th carry signal received through a (k+1)-th carry terminal; and
a reset unit configured to reset the voltage of the first node to the ground voltage in response to a reset signal received through a reset terminal,
wherein the reset unit receives one of the k-th gate signal and the k-th carry signal as a feedback signal.

2. The gate driving circuit of claim 1, wherein the reset unit comprises:
a first reset transistor comprising a first electrode connected to the first node, a second electrode connected to a connection node, and a gate electrode connected to the reset terminal; and
a second reset transistor comprising a first electrode connected to the connection node, a second electrode connected to the ground voltage, and a gate electrode connected to the reset terminal,
wherein the feedback signal is provided to the connection node.

3. The gate driving circuit of claim 2, wherein the reset unit further comprises a feedback transistor comprising a first electrode connected to the k-th gate line, a second electrode connected to the connection node, and a gate electrode connected to the k-th gate line.

4. The gate driving circuit of claim 2, wherein the reset unit further comprises a feedback transistor comprising a first electrode connected to the k-th carry terminal, a second electrode connected to the connection node, and a gate electrode connected to the k-th carry terminal.

5. The gate driving circuit of claim 1, wherein the reset unit further comprises a third reset transistor comprising a first electrode connected to the k-th gate line, a second electrode connected to the ground voltage, and a gate electrode connected to the reset terminal.

6. The gate driving circuit of claim 1, wherein the reset unit further comprises a fourth reset transistor comprising a first electrode connected to the k-th carry terminal, a second electrode connected to the ground voltage, and a gate electrode connected to the reset terminal.

7. The gate driving circuit of claim 1, wherein the output unit comprises:
a first output transistor comprising a first electrode configured to receive a clock signal, a second electrode configured to output the k-th gate line that is generated based on the clock signal, and a gate electrode connected to the first node; and
a second output transistor comprising a first electrode configured to receive the clock signal, a second electrode configured to output the k-th carry signal that is generated based on the clock signal, and a gate electrode connected to the first node.

8. The gate driving circuit of claim 1, wherein the control unit outputs a first control signal to the first node in response to a (k−1)-th carry signal from a (k−1)-th carry terminal before the k-th gate signal is outputted.

9. The gate driving circuit of claim 8, wherein the control unit comprises first and second control transistors connected in series between the (k−1)-th carry terminal and the first node, and
wherein each of the first and second control transistors has a gate electrode connected to the (k−1)-th carry terminal.

10. The gate driving circuit of claim 9, further comprising a third control transistor diode-connected to a connection node between the k-th carry terminal and first and second output transistors of the output unit.

11. The gate driving circuit of claim 1, further comprising a discharge unit comprising first and second discharge transistors connected in series between the first node and the ground voltage, and
wherein each of the first and second discharge transistors has a gate electrode connected to the (k+1)-th carry terminal.

12. The gate driving circuit of claim 1, wherein the reset unit comprises:
a first reset transistor diode-connected between the first node and a connection node; and
a second reset transistor comprising a first electrode connected to the connection node, a second electrode connected to the ground voltage, and a gate electrode connected to the reset terminal.

13. A display apparatus comprising:
a display panel comprising a plurality of pixels configured to display an image, a plurality of gate lines configured to receive a plurality of gate signals so as to drive the plurality of pixels, and a plurality of data lines configured to receive a plurality of data signals;
a gate driving circuit on the display panel, the gate driving circuit being configured to supply the gate signals to the plurality of gate lines; and
a data driving circuit configured to supply the data signals to the plurality of data lines,
wherein the gate driving circuit comprises: a plurality of driving stages configured to supply the gate signals to the gate lines, a k-th driving stage (where k is a natural number greater than 2) of the plurality of driving stages comprising:
an output unit configured to output a k-th gate signal to a k-th gate line of the gate lines and a k-th carry signal to a k-th carry terminal in response to a voltage of a first node;
a control unit configured to control a potential of the first node;
a pull-down unit configured to pull down the k-th gate line and the k-th carry terminal to a ground voltage in response to a (k+1)-th carry signal received through a (k+1)-th carry terminal; and
a reset unit configured to reset the voltage of the first node to the ground voltage in response to a reset signal received through a reset terminal,
wherein the reset unit receives one of the k-th gate signal and the k-th carry signal as a feedback signal.

14. The display apparatus of claim 13, wherein the reset unit comprises:
a first reset transistor comprising a first electrode connected to the first node, a second electrode connected to a connection node, and a gate electrode connected to the reset terminal; and
a second reset transistor comprising a first electrode connected to the connection node, a second electrode connected to the ground voltage, and a gate electrode connected to the reset terminal,
wherein the feedback signal is provided to the connection node.

15. The display apparatus of claim 14, wherein the reset unit further comprises a feedback transistor comprising a first electrode connected to the k-th gate line, a second electrode connected to the connection node, and a gate electrode connected to the k-th gate line.

16. The display apparatus of claim 14, wherein the reset unit further comprises a feedback transistor comprising a first electrode connected to the k-th carry terminal, a second electrode connected to the connection node, and a gate electrode connected to the k-th carry terminal.

17. The display apparatus of claim 13, wherein the reset unit further comprises a third reset transistor comprising a first electrode connected to the k-th gate line, a second electrode connected to the ground voltage, and a gate electrode connected to the reset terminal.

18. The display apparatus of claim 13, wherein the reset unit further comprises a fourth reset transistor comprising a first electrode connected to the k-th carry terminal, a second electrode connected to the ground voltage, and a gate electrode connected to the reset terminal.

19. The display apparatus of claim 13, wherein the gate driving circuit comprises a plurality of oxide semiconductor transistors.
